(19) United States
(12) Patent Application Publication
(10) Pub. No.: US 2004/0153471 A1
(43) Pub. Date: Aug. 5, 2004

(54) Method and program for storing performance data, and system using the same

(75) Inventors: Nobuyuki Saika, Yokosuka (JP); Shuji Fujimoto, Yokohama (JP); Minori Awakura, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/649,124

(22) Filed: Aug. 26, 2003

(30) Foreign Application Priority Data
Jan. 31, 2003 (JP) 2003-025073

(51) Int. Cl. G06F 17/00

(52) U.S. Cl. 707/104.1

(57) ABSTRACT

A data management method for managing performance data of a computer system which includes: a storage area for storing the performance data as data including performance information of the computer system and other data; and a controller for controlling the storage area, is provided. The data management method includes: a step in which the controller detects free space of the storage area; a step in which the controller determines a method for storing the performance data depending on the detected free space; a step in which the controller acquires the performance data; and a step in which the controller stores the acquired performance data in the storage area according to the storing method determined in the method determination step.

### BACKGROUND OF THE INVENTION

The present invention relates to a method, a controller and a program for managing data.

Monitoring the performance of a computer system makes it possible to find out and grasp factors deteriorating or improving the performance of the system, by which proper countermeasures can be taken immediately in case of problems. The performance monitoring is especially important to large-scale computer systems of today in order to unleash their performance efficiently and stably. For example, it is possible to provide a computer system with a performance monitoring device for the purpose of maintaining the processing speed, maintaining the data transfer rate, reserving memory/disk spaces, etc. and let the device monitor the performance of the system (CPU, memory, disk, I/O interface, network controller, etc.), acquire performance information at preset time intervals, and store the acquired information in a storage device as performance data.

Conventional performance monitoring devices for computer systems have monitored and recorded predetermined and fixed performance items with fixed timing, and performance monitoring techniques changing the monitoring method depending on other factors have rarely been reported except for few exceptions (JP-A-2001-325126, for example).

The performance data of a computer system are generally acquired and stored in a storage device as log files. However, since the storage device has to store a variety of data other than the log files, storage capacity for storing other data might be affected by increasing volume of the log files stored in the storage device.

### SUMMARY OF THE INVENTION

It is therefore the primary object of the present invention to provide a method for managing the performance data of a computer system by which a storage area of the storage device for storing the performance data and other data can be used more efficiently.

In accordance with an aspect of the present invention, there is provided a data management method for managing performance data of a computer system which includes: a storage area for storing the performance data as data including performance information of the computer system and other data; and a controller for controlling the storage area, comprising the steps of: a step in which the controller detects free space of the storage area; a step in which the controller determines a method for storing the performance data depending on the detected free space; a step in which the controller acquires the performance data; and a step in which the controller stores the acquired performance data in the storage area according to the storing method determined in the method determination step.

In a storage system, the storage area is implemented by an LU (Logical Unit) or logical volume which is logically set in a storage device, and the controller for controlling the storage area (storage device) is implemented by a storage device controller.

The above object of the present invention can also be achieved by a program realizing the above steps or a record medium storing the program.

The objects and features of the present invention will become more apparent from the consideration of the following detailed description taken in conjunction with the accompanying drawings.

### BRIEF DESCRIPTION OF THE DRAWINGS

FIG. 1 is a block diagram showing an example of the composition of a storage system in accordance with an embodiment of the present invention;

FIG. 2 is a table showing an example of “acquisition level definition” employed in the embodiment;

FIG. 3 is a table showing an example of “acquisition item definition” employed in the embodiment;

FIG. 4 is a schematic diagram showing an example of an output file including the performance data;

FIG. 5 is a table showing an example of “initial policy definition” employed in the embodiment;

FIG. 6 is a table showing an example of “policy definition” employed in the embodiment;

FIG. 7 is a table showing selectable methods for controlling a performance data area according to “stop operation policy” employed in the embodiment;

FIG. 8 is a flow chart showing the operation of the storage system when a performance management program according to the embodiment is executed;

FIG. 9 is a flow chart showing the operation of the storage system according to the “initial policy definition”;

FIG. 10 is a flow chart showing the operation of the storage system according to the “policy definition”;

FIG. 11 is a flow chart showing the operation of the storage system when a performance management program according to another embodiment of the present invention is executed; and

FIG. 12 is a block diagram showing an example of the composition of a storage system in accordance with another embodiment of the present invention, in which a storage device controller including channel control modules is employed.

### DETAILED DESCRIPTION OF THE EMBODIMENTS

Referring now to the drawings, a description will be given in detail of preferred embodiments in accordance with the present invention.

1. Example of Overall Composition

A storage system 100 includes a storage device 200 and a storage device controller 300. The storage device controller 300 controls the storage device 200 according to commands (input requests, output requests, etc.) supplied from an information processing device 400 outside the storage system 100. For example, the storage device controller 300 receives a data write request and data from the information processing device 400 and carries out data write to the storage device 200. The data is stored in an LU (Logical Unit) or logical volume which is logically set as a storage area in a physical storage area provided by disk drives of the storage device 200. The storage device controller 300 also receives/sends various commands for managing the storage system 100 itself from/to the information processing device 400.

The information processing device 400 is a computer including a CPU (Central Processing Unit) and memory. Various programs are executed by the CPU of the information processing device 400 and thereby a diversity of functions are realized. The information processing device 400 can be implemented by, for example, a personal computer, a workstation or a mainframe computer.

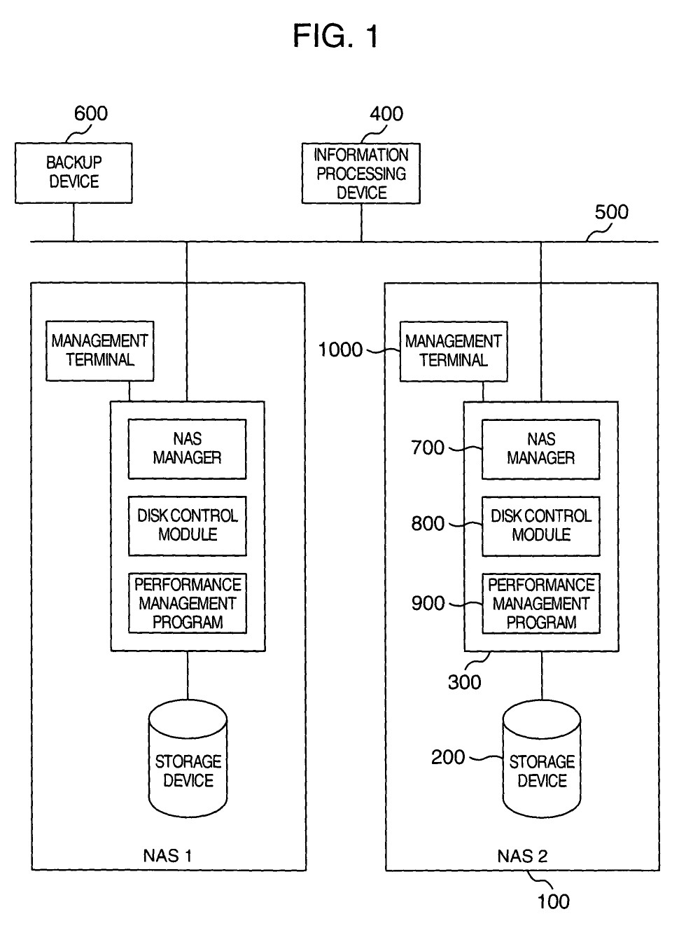

While the information processing device 400 is connected to the storage device controller 300 via a LAN (Local Area Network) 500 in FIG. 1, the connection can also be provided by other types of networks such as a SAN (Storage Area Network) or by direct connection. The LAN 500 may be built up totally by a private special-purpose network, or by use of the Internet. The communication between the information processing device 400 and the storage device controller 300 via the LAN 500 is carried out according to TCP/IP (Transmission Control Protocol/Internet Protocol), for example. From the information processing device 400, data access requests designating file names (also referred to as “file access requests”) are transmitted to the storage system 100.

The LAN 500 is also connected to a backup device 600. The backup device 600 can be implemented by a device using disks (MO, CD-R, DVD, etc.), a device using tapes (DAT, cassette tapes, open tapes, cartridge tapes, etc.), or a device using an HDD (Hard Disk Drive). The backup device 600 communicates with the storage device controller 300 via the LAN 500 and thereby stores backup data in order to back up the data stored in the storage device 200 of the storage system 100. The backup device 600 may also be connected to the information processing device 400. In this case, the backup device 600 obtains the backup data from the storage device 200 via the information processing device 400.

2. Storage Device

The storage device 200 includes a plurality of disk drives (physical disks) and thereby provides storage areas to the information processing device 400. As the disk drives, various types of devices (HDDs, removable disk devices, semiconductor storage devices, etc.) can be employed. Data are stored in the aforementioned LUs (storage areas logically set in the physical storage area provided by the disk drives of the storage device 200). Each LU set in the storage device 200 can be accessed from the information processing device 400 and other terminals on the LAN 500 in order to input/output data.

Incidentally, the storage device 200 can also be built up as a disk array composed of a plurality of disk drives. In this case, the storage area to be provided to the information processing device 400 may be implemented by a plurality of disk drives managed by RAID (Redundant Array of Independent Disks).

The storage device controller 300 and the storage device 200 can be directly connected together as components of the storage system 100 as shown in FIG. 1, or the storage device 200 can also be placed outside the storage system 100 and connected to the system via a network. It is also possible to build up the storage device 200 and the storage device controller 300 integrally.

3. Storage Device Controller

The storage device controller 300 has a communication interface for communicating with the information processing device 400 and functions for communicating commands (data input/output commands, etc.) with the information processing device 400, by which the storage system 100 can provide services as a NAS (Network Attached Storage) to the information processing device 400.

The storage device controller 300 further includes a NAS manager 700 for checking, setting and controlling the operating statuses of the storage system 100, a disk control module 800 for controlling the storage device 200, and a performance management program 900 for managing the performance data. The storage device controller 300 employs an OS (Operating System) such as UNIX (registered trademark). The NAS manager 700, the disk control module 800 and the performance management program 900 operate on the operating system together with a variety of software such as a RAID manager, volume manager, SVP manager, file system program, network control module, backup management program, and failure management program.

Along with the functions for checking, setting and controlling the operating statuses of the storage system 100, the NAS manager 700 also has a Web server function, by which the NAS manager 700 provides the information processing device 400 with a “setting web page” for letting operators of the information processing device 400 set and control the storage system 100. The NAS manager 700 transmits data of the setting web page to the information processing device 400 according to an HTTP (Hyper Text Transport Protocol) request issued by the information processing device 400. At the information processing device 400, an operator such as a system administrator sets and controls the storage system 100 through the setting web page displayed by a GUI (Graphical User Interface). The NAS manager 700 receives data regarding the setting and control (according to the operation on the setting web page) from the information processing device 400 and actuarially sets and controls the storage system 100 corresponding to the data. By the process, the operator at the information processing device 400 can set and control the storage system 100 in various ways. The setting/control possible on the setting web page provided by the NAS manager 700 include: setting/management of the storage device 200 (capacity management, capacity expansion/reduction, user assignment, etc.); setting/control regarding the aforementioned remote copy and replication management (setting of a replication source LU, replication destination LU, etc.); version control of the OS and application programs operating on the OS; setting/management of operating statuses of a virus detection program and a security management program offering functions for the safety of data (virus extermination, etc.); etc.

The disk control module 800 controls the storage device 200. For example, when the storage device controller 300 received a data write command and data from the information processing device 400, the disk control module 800 writes the data to the storage device 200 according to the data write command. The disk control module 800 also converts a data access request to an LU (designating a logical address) into a data access request to a physical disk (designating a physical address). Further, when the physical disks of the storage device 200 are managed by RAID, the disk control module 800 makes access to the storage device 200 according to a certain RAID configuration (e.g. RAID 0, 1, 5). The disk control module 800 also controls the replication and backup of the data stored in the storage device 200. Further, the disk control module 800 controls a process for storing data stored in a storage system 100 of a primary site also in another storage system 100 of a secondary site (replication function, remote copy function) in order to prevent loss of data in case of disaster etc. (disaster recovery).

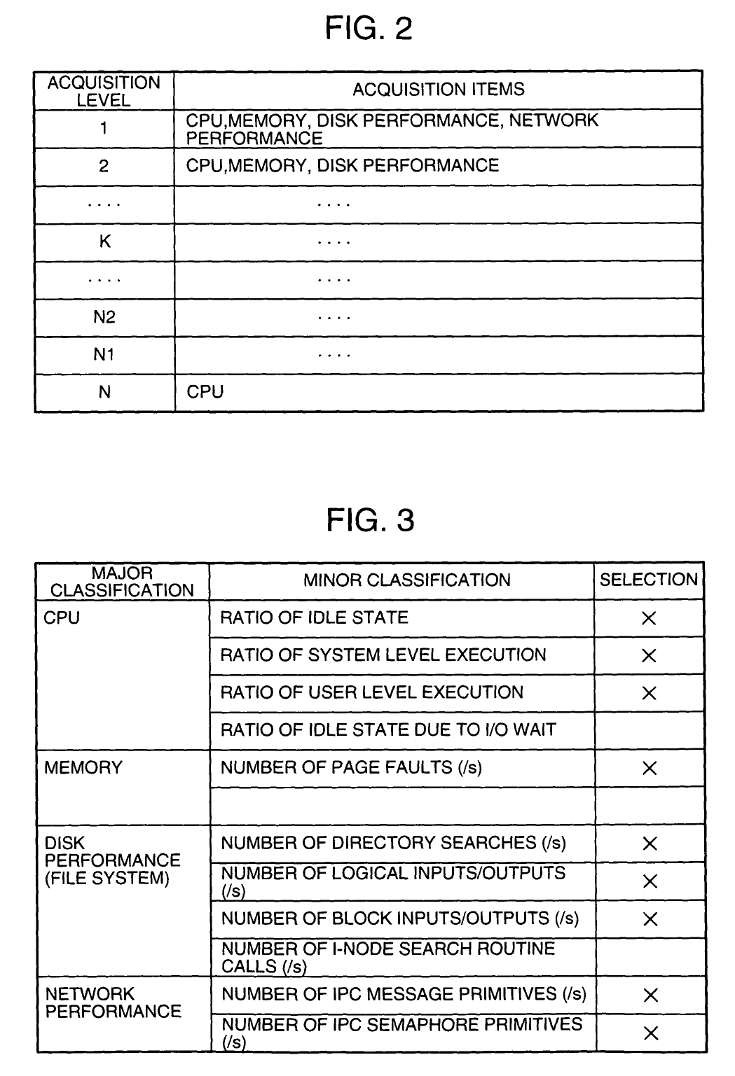

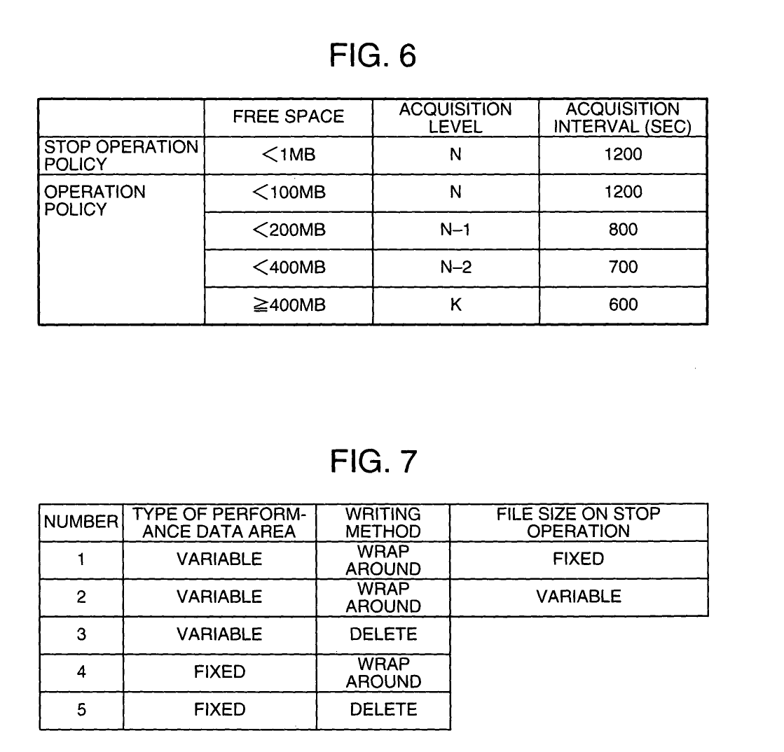

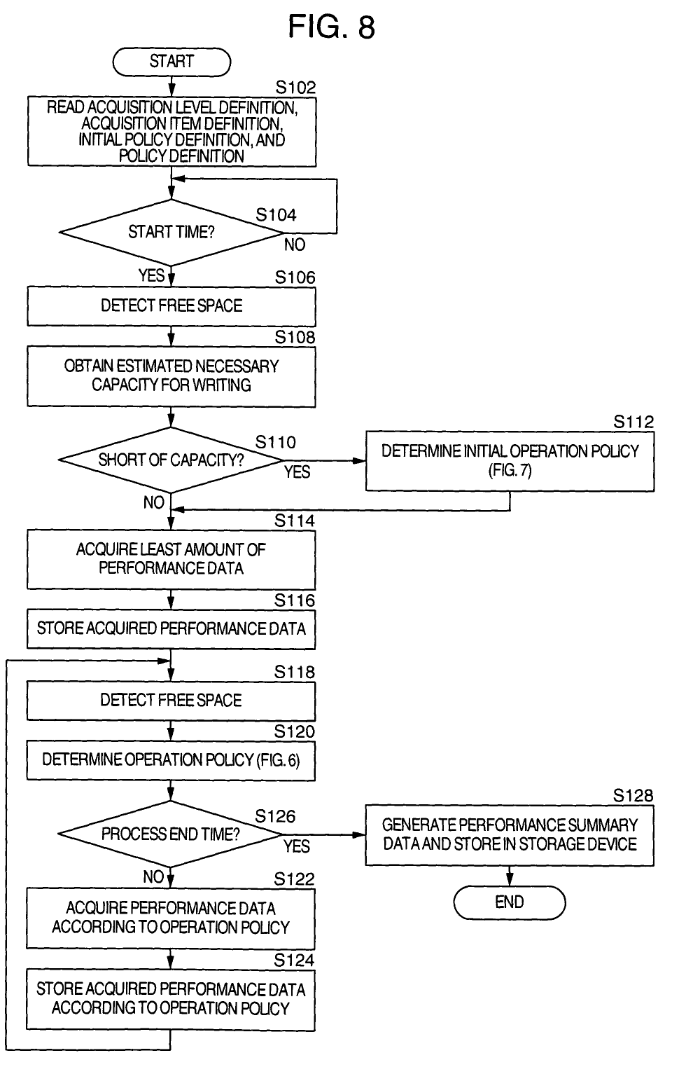

The performance management program 900 monitors performance data of the computer system (like those shown in “acquisition items” of FIG. 2), acquires the performance data according to “policy definition” (FIG. 6) which will be described later, and stores the acquired performance data in the storage device 200 via the disk control module 800 in the form of log files, for example.

4. Management Terminal

A management terminal 1000 is a computer for the maintenance/management of the storage system 100. By manipulating the management terminal 1000, settings of the physical disks (increase/decrease of physical disks, etc.) and settings of the LUs of the storage device 200 can be adjusted. Further, with the management terminal 1000, checks on operating statuses of the storage system 100, location of failure, installation of an operating system, etc. can be done. The management terminal 1000 is connected to an external maintenance center via a line (LAN, telephone line, etc.), therefore, failures of the storage system 100 can be monitored and countermeasures against the failures can be taken immediately by use of the management terminal 1000. The occurrence of failure is reported by, for example, the OS, an application software or a driver software by use of HTTP, SNMP (Simple Network Management Protocol), e-mails, etc. Such settings and control are carried out by an operator etc. using a web page (provided by a Web server and operating on the management terminal 1000) as a user interface. The operator etc. can also set the object of the failure monitoring, details of the failure monitoring, where to report the failures, etc. by operating the management terminal 1000.

The management terminal 1000 can be built in the storage device controller 300 or provided externally to the storage device controller 300. The management terminal 1000 can be implemented as a special-purpose computer exclusively used for the maintenance and management of the storage device controller 300 and the storage device 200, or as a general-purpose computer having the maintenance/management functions.

5. Embodiment 1

In a first embodiment of the present invention, the amount of free space or free area of the storage device 200 for storing acquired performance data is detected, the method for storing the acquired performance data is determined depending on the free space, and then the acquired performance data is written in the storage device 200 according to the method (hereafter, referred to as “performance data area variable type”), by which a capacity in the storage device 200 to be occupied by the performance data can be set taking the free space of the storage device 200 into consideration. The relationship between the importance of the performance data and that of other data varies depending on cases. When the storage device 200 has a large free space and enough room for other data can be expected even if the amount of performance data increased, acquiring and storing performance data frequently and/or in large quantities is advantageous to the performance management of the computer system. On the other hand, when the free space of the storage device 200 is small and storing the performance data in the storage device 200 might affect the room for other data, the amount of performance data to be stored has to be reduced to a minimum. The first embodiment, taking such point in consideration, realizes efficient use of the storage device 200 which has to store the performance data as well as other data. In the first embodiment, the number of items of performance data to be acquired, the contents of the acquired items, and the write interval are determined and set based on the free space of the storage device 200.

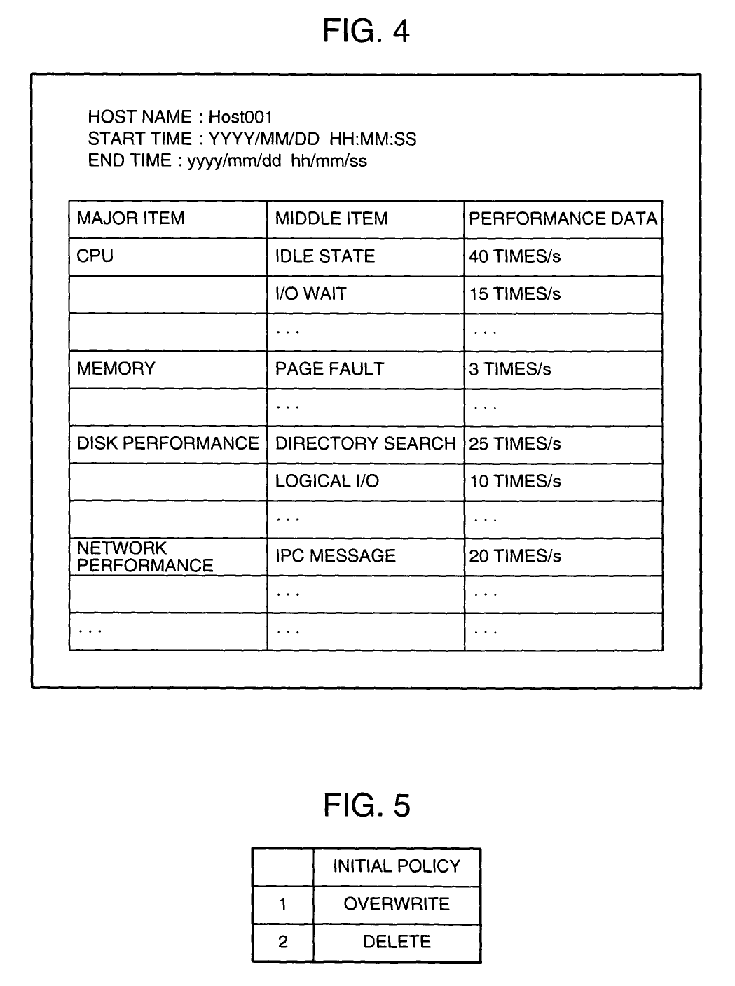

First, “acquisition level definition” shown in FIG. 2, “acquisition item definition” shown in FIG. 3, “initial policy definition” shown in FIG. 5, and “policy definition” shown in FIG. 6, are specified at the information processing device 400. In the “acquisition level definition” (FIG. 2), combinations of items (targets) of performance data acquisition (combinations of types of performance data to be acquired) are roughly defined by extracting them from the performance of the computer system (CPU, memory, disk performance, network performance, etc.), and an “acquisition level” is defined for each combination. In the “acquisition item definition” (FIG. 3), the items (targets) of the performance data acquisition are defined more finely by segmenting the items (CPU, memory, disk performance, network performance, etc.) defined in the “acquisition level definition” so that actual targets of the performance data acquisition can be selected and specified at the information processing device 400. An example of an output file generated according to the “acquisition item definition” is shown in FIG. 4.

The “initial policy definition” (FIG. 5) is used when an estimated necessary capacity (estimated capacity necessary for storing all performance data to be acquired during a processing time) exceeds the free space of the storage device 200 at the first (initial) storing of the performance data in the storage device 200, in which methods for handling or processing performance data already stored in the storage device 200 are defined. Specifically, the handling method can be selected from “overwrite” and “delete”. If the “overwrite” is selected, a free space necessary for storing a new file of performance data is obtained and reserved in the storage device 200 by deleting some of existing files starting from the oldest file and then the new file is written. If the “delete” is selected, all the old files (performance data) stored in the storage device 200 are deleted. In the “policy definition” (FIG. 6), statuses that can be found in a stationary state of the system are defined and actions to be taken (how to write the performance data) in each of the defined statuses are defined. When the capacity (free space) of the storage device 200 became less than a preset capacity, the operation of the storage device 200 is controlled according to “stop operation policy” which is shown in FIG. 7. First, whether the capacity of a “performance data area” (area in the storage device 200 for storing performance data) is fixed or varied can be selected. The first embodiment corresponds to the cases where the performance data area capacity is varied (No. 1-No. 3 in FIG. 7). Further, in regard to the method for storing the performance data, a selection can be made from “wrap around” (No. 1, No. 2) and “delete” (No. 3). If the “wrap around” is selected, the performance data area is assigned a preset capacity and performance data are initially written successively in the performance data area of the preset capacity. When the performance data area ran out of free space, new files of performance data will be written in the performance data area by deleting existing files one by one starting from the oldest file. The method, holding and preserving a certain amount of previous data, has an advantage in that some performance data of the past can be retrieved when necessary. If the “delete” is selected, performance data that have been stored in the performance data area at the point are all deleted and then a new file is written. When the free space of the storage area has become too small, holding previous performance data might make it impossible to reserve a storage area for other data. In such cases, the method, deleting all previous performance data and thereby releasing a storage capacity or free space, is preferable.

In the following, a process carried out by the performance management program 900 from process start time to process end time will be described with reference to a flow chart of FIG. 8. First, the performance management program 900 reads out the “acquisition level definition” of FIG. 2, the “acquisition item definition” of FIG. 3, the “initial policy definition” of FIG. 5, and the “policy definition” of FIG. 6 (S102) and then waits until the process start time (S104). When the process start time has come (S104: YES), the amount of free space of the storage device 200 for storing the performance data is detected (S106). In order to judge and predict whether all of the performance data to be acquired during the processing time (between the process start time and the process end time) can be accommodated in the free space, the aforementioned “estimated necessary capacity” for storing all performance data to be acquired in the processing time is calculated by, for example, the following expression (S108):

(the number of times of acquisition)

×(average data size among items)

×(the number of acquired items)

Each parameter in the above expression can be estimated from data of previously conducted processes by certain algorithm, or can be inputted as external variables by an operator, or can also be inputted from the management terminal 1000. Incidentally, when the process is conducted for the first time, the steps 106 through 112 are omitted since nothing has been written in the storage device 200. Subsequently, the free space of the storage device 200 is compared with the estimated necessary capacity (S110). If the estimated necessary capacity is larger than the free space of the storage device 200 (S110: YES), continuing the process is expected to cause impossibility of writing performance data, therefore, performance data already stored in the storage device 200 are processed according to the method selected in the “initial policy definition” of FIG. 5 in order to reduce the amount of the stored performance data in advance (S112). On the other hand, if the estimated necessary capacity is larger than the free space of the storage device 200 (S110: NO), the performance data already stored in the storage device 200 are left as they are. In either case, the performance data are acquired in minimum necessary quantities (S114) and the acquired performance data are stored in the storage device 200 (S116). Subsequently, the free space of the storage device 200 is detected again (S118) and an operation policy corresponding to the free space is determined according to the “policy definition” (S120). Thereafter, according to the operation policy, performance data are acquired (S122), the acquired performance data are stored in the storage device 200 (S124), and the process is returned to the step S118. If the process end time came before the acquisition of the performance data (S126: YES), performance summary data are generated from the performance data acquired during the processing time (S128), and the process is ended.

In the operation policy of FIG. 6, the number of types (items) of performance data to be acquired is increased and the write interval is shortened as the free space of the storage device 200 gets larger. On the other hand, when the free space is small, the number of types of acquired performance data is decreased and the write interval is extended in order to avoid the erosion of other data (user data, etc.) by the performance data.

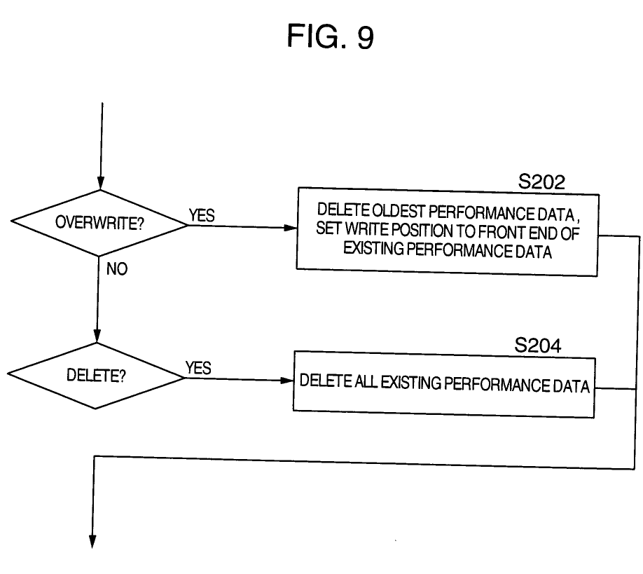

FIG. 9 is a flow chart showing the details of the process according to the “initial policy definition”. If the “overwrite” has been selected in the “initial policy definition”, the write position is set to the front end of the performance data stored in the storage device 200 so that a free space necessary for storing a new file will be reserved by deleting some of existing files starting from the oldest file (S202). If the “delete” has been selected in the “initial policy definition”, all existing performance data are deleted (S204).

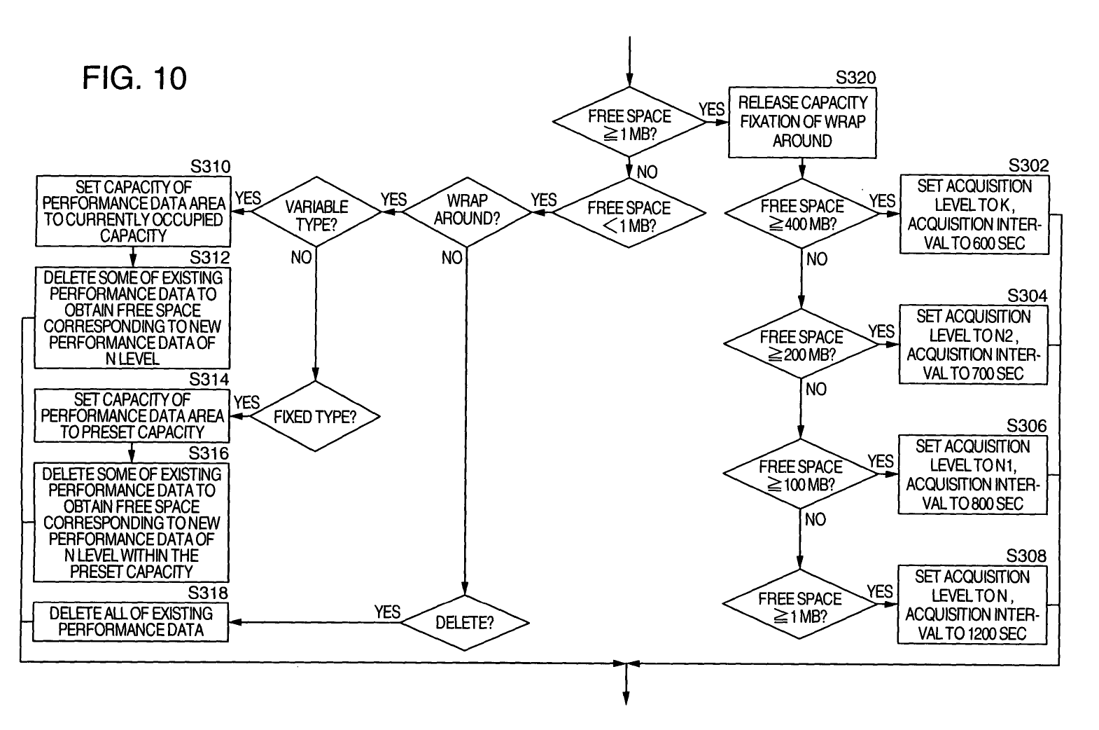

FIG. 10 is a flow chart showing the details of the process according to the “policy definition”. In the process, the acquisition level and the write interval of the performance data are basically determined based on the free space of the storage device 200 (S302-S308). However, if the free space is smaller than (or equal to) a preset value (when the free space is less than 1 MB in the example of FIG. 10), previously stored performance data are processed according to the aforementioned “stop operation policy”, the acquisition level of the performance data to be acquired is reduced to the lowest level, and the write interval is set to the longest.

If the “wrap around” has previously been selected in the “stop operation policy”, the performance data area is assigned a preset capacity and acquired performance data are initially written successively in the performance data area of the preset capacity, and when the performance data area ran out of free space, new performance data files will be written in the performance data area by deleting existing performance data files one by one starting from the oldest file, as mentioned before. In this case, there are two types of the performance data area: the “variable type” in which the capacity of the performance data area is variably set to the current capacity occupied at the point (S310) and the “fixed type” in which the performance data area capacity is set to the preset capacity (S314). In the “variable type”, before storing a new performance data file, some of old performance data files are deleted in order to reserve a free space for the new file (S312) and then the new file is stored (S124). The “variable type” has an advantage in that previous performance data files can be preserved for a relatively long time. In the “fixed type”, the capacity of the performance data area is previously set to the preset capacity (S314), and when new performance data are stored, some of existing performance data are deleted starting from the oldest file so as to reduce their volume to the preset capacity and further to reduce the volume by the size of the new performance data file to be stored (S316) and then the new performance data file is stored (S124). If the size of the new performance data file to be acquired is set as the lowest level (i.e. N level in the present embodiment) in this case, it has an advantage in that previous performance data files can be preserved more. The method has an advantage in that even when the free space of the storage device 200 has become small, the area in the storage device 200 occupied by the performance data files can be reduced to some extent by the deletion of performance data files. The particular capacity assigned to the performance data area is maintained during the “stop operation policy”; however, when the operation policy has recovered from the “stop operation policy” (when the free space of the storage device 200 has become larger than the preset value due to deletion of other data such as user data), the fixed capacity of the performance data area which has been set for the “wrap around” is released (S320). On the other hand, if the “delete” has previously been selected in the “stop operation policy”, all the existing performance data are deleted (S318).

Incidentally, while the steps: the free space detection and operation policy determination; data acquisition; data storing; etc. have been described as a sequence of steps occurring in that order, they are originally independent steps and there is no problem even if the order of the steps changed or some time difference arose between the steps. While the types of the performance data acquisition items and the write interval were changed as an example in the data acquisition method of this embodiment, various combinations between them are also possible and features changed are not limited to them.

The performance management program 900 can also be provided with backup algorithm for backing up data when or before the existing data are deleted. The backup may be made in a step before the deletion, in particular steps only, etc. The algorithm may also make a backup of the performance summary data for all or part of the backup. The backup data may be stored in the backup device 600 or can also be transmitted to another NAS.

6. Embodiment 2

In a second embodiment of the present invention, the capacity of the performance data area in the storage device 200 for storing the performance data is fixed (hereafter, referred to as “performance data area fixed type”), by which situations where the user area of the storage device 200 is constricted by the increase of performance data can be avoided.

The composition of the storage system 100 is the same as that in the first embodiment and thus repeated description thereof is omitted. The operator of the information processing device 400 can make a selection regarding the “policy definition” (FIG. 6) from the “performance data area fixed type” (in which the performance data area capacity is fixed) and the “performance data area variable type” (in which the performance data area capacity is variable) as shown in FIG. 7. The second embodiment corresponds to the latter type (No. 4 and No. 5 in FIG. 7).

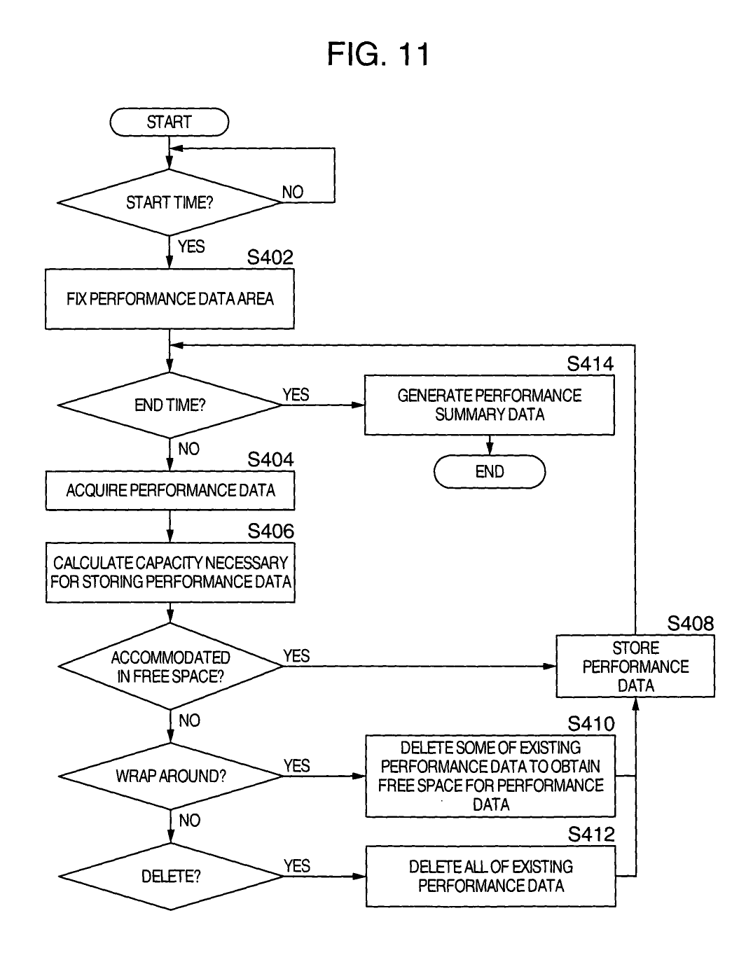

In the following, a process conducted by the performance management program 900 of the second embodiment for managing the performance data will be described with reference to a flow chart of FIG. 11. First, the performance management program 900 reserves a capacity in the storage device 200 for the performance data area and fixes the capacity (S402). Subsequently, performance data is acquired (S404) and data capacity necessary for storing the performance data in the storage device 200 is calculated (S406). The method for storing the performance data can be selected from “wrap around” (No. 4 in FIG. 7) and “delete” (No. 5 in FIG. 7). If the “wrap around” has been selected, the performance data are initially written successively in the performance data area of the fixed capacity (S408) and when the performance data area ran out of free space, new files will be written in the performance data area successively (S408) by deleting existing files one by one starting from the oldest file (S410). If the “delete” has been selected, the performance data are initially written successively in the performance data area of the fixed capacity (S408) and when the performance data area ran out of free space, all the existing performance data are deleted (S412) and then new performance data are successively written in the performance data area (S408). When the process end time has come, the performance summary data are generated from the stored performance data (S414), and the process is ended.

The performance summary data are handled in the same as in the first embodiment and thus repeated description thereof is omitted here.

7. Performance Summary Data

The performance summary data are data that are obtained by extracting essential part from the performance data, by taking mean values from the performance data, etc., which indicate overall features of the whole performance data. Therefore, it is possible to store the performance data as the summary data once in a preset number of performance data acquisitions, or performance figures such as processing speed may be averaged once in a preset number of times and stored as the summary data. Or, it is also possible to extract particular types of data from the performance data as the summary data (storing performance data of the CPU only, for example). The contents of the summary data and the frequency of the summary data storing may be changed depending on the load on the computer system.

In the above embodiments, the performance summary data obtained in a storage system 100 (NAS) may be transmitted to a specific NAS, by which the performance summary data of all the NAS's are collected by the specific NAS receiving the performance summary data. In this case, the operator of the information processing device 400 is allowed to obtain the performance summary data of all the storage devices by only making access to the storage device 200 of the specific NAS, by which performance of all the storage devices can be compared easily. Therefore, the occurrence of failure to a storage device 200 can be found out easily by monitoring the performance summary data collected by the specific NAS.

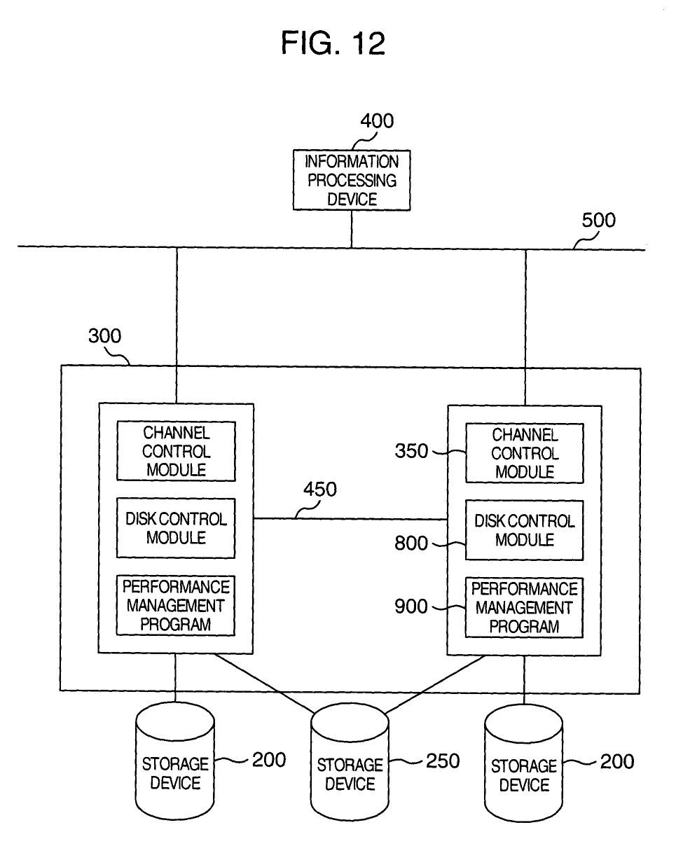

As another embodiment in accordance with the present invention, a storage device controller 300 having channel control modules 350 is also possible as shown in FIG. 12. The storage device controller 300 communicates with the information processing device 400 via the LAN 500 using the channel control modules 350. Each channel control module 350 receives file access requests from the information processing device 400 separately and independently, that is, each channel control module 350 is assigned a separate network address (e.g. IP address) on the LAN 500 and serves as an independent NAS, by which the channel control modules 350 can provide NAS services to the information processing device 400 as if there are a plurality of independent NAS's. By building up a storage system 100 so as to include two or more channel control modules 350 separately providing NAS services as in this embodiment, NAS servers (which have been operated independently by separate computers) can be operated in an aggregated manner in a storage system 100, by which centralized management of the storage system 100 becomes possible and the efficiency of maintenance tasks (various settings and control, failure management, version control, etc.) can be increased.

Such a storage system 100 composed as above can also be provided with a storage device 250 that is shared by a plurality of channel control modules 350. In this case, performance data of each channel control module 350 are acquired and stored in a storage device 200 corresponding to the channel control module 350; however, the performance summary data may be sent to the shared storage device 250 and stored therein. In cases where the performance summary data are aggregated to a channel control module 350, for example, it is possible to communicate the performance summary data via an internal LAN 450. Even in such composition, the performance summary data may be communicated via the external LAN.

As set forth hereinabove, by the present invention, a method for managing the performance data of a computer system, capable of efficiently using a storage area storing the performance data and other data, is provided.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. A data management method for managing performance data of a computer system which includes: a storage area for storing the performance data as data including performance information of the computer system and other data; and a controller for controlling the storage area, comprising:
a step in which the controller detects free space of the storage area;
a step in which the controller determines a method for storing the performance data depending on the detected free space;
a step in which the controller acquires the performance data; and
a step in which the controller stores the acquired performance data in the storage area according to the storing method determined in the method determination step.

2. The data management method according to claim 1, wherein the storing method determined in the method determination step includes:
types of performance data to be stored; and/or
timing of the storing of the performance data.

3. The data management method according to claim 1, wherein the storing step includes:
a step in which the controller stores the acquired performance data in the storage area if the detected free space is larger than a preset capacity; and
a step in which the controller deletes performance data already stored in the storage area and then stores the acquired performance data in the storage area if the detected free space is smaller than the preset capacity.

4. The data management method according to claim 1, wherein the storing step includes:
a step in which the controller calculates a performance data capacity necessary for recording the acquired performance data in the storage area;
a step conducted if the detected free space is larger than a preset capacity, in which the controller stores the acquired performance data in the storage area; and
a step conducted if the detected free space is smaller than the preset capacity, in which the controller assigns a capacity to a performance data area for storing the performance data so that the capacity will be substantially the same as the amount of existing performance data already stored in the storage area, deletes some of the existing performance data so that the amount of the existing performance data will be reduced by at least the calculated performance data capacity, and stores the acquired performance data in the storage area.

5. A data management method for managing performance data of a computer system which includes: a storage area for storing the performance data as data including performance information of the computer system and other data; and a controller for controlling the storage area, comprising:
a step in which the controller detects free space of the storage area;
a step conducted if the detected free space is larger than a first preset capacity, in which the controller determines a method for storing the performance data depending on the detected free space, acquires the performance data, and stores the acquired performance data in the storage area according to the storing method;
a step conducted if the detected free space of the storage area is smaller than the first preset capacity and the amount of existing performance data already stored in the storage area is smaller than a second preset capacity, in which the controller acquires the performance data, calculates a performance data capacity necessary for recording the acquired performance data in the storage area, stores the acquired performance data in the storage area if the sum of the calculated performance data capacity and the amount of the existing performance data already stored in the storage area is smaller than the second preset capacity, and deletes some of the existing performance data so that the sum will become the second preset capacity or less and then stores the acquired performance data in the storage area if the sum is larger than the second preset capacity; and
a step conducted if the detected free space of the storage area is smaller than the first preset capacity and the amount of the existing performance data already stored in the storage area is larger than the second preset capacity, in which the controller acquires the performance data, calculates the performance data capacity necessary for recording the acquired performance data in the storage area, deletes some of the existing performance data so that the sum will become the second preset capacity or less, and stores the acquired performance data in the storage area.

6. A data management method for managing performance data of a computer system which includes: a storage area for storing the performance data as data including performance information of the computer system and other data; and a controller for controlling the storage area, comprising:
a step in which the controller assigns the storage area a preset storage capacity for storing the performance data;
a step in which the controller acquires the performance data;
a step in which the controller calculates a performance data capacity necessary for recording the acquired performance data in the storage area;
a step conducted if the calculated performance data capacity is smaller than free space in the assigned storage capacity, in which the controller stores the acquired performance data in the storage area; and
a step conducted if the calculated performance data capacity is larger than the free space in the assigned storage capacity, in which the controller deletes existing performance data already stored in the storage area and then stores the acquired performance data in the storage area.

7. A data management method for managing performance data of a computer system which includes: a storage area for storing the performance data as data including performance information of the computer system and other data; and a controller for controlling the storage area, comprising:
a step in which the controller assigns the storage area a preset storage capacity for storing the performance data;
a step in which the controller acquires the performance data;
a step in which the controller calculates a performance data capacity necessary for recording the acquired performance data in the storage area;
a step conducted if the calculated performance data capacity is smaller than free space in the assigned storage capacity, in which the controller stores the acquired performance data in the storage area; and
a step conducted if the calculated performance data capacity is larger than the free space in the assigned storage capacity, in which the controller deletes some of existing performance data already stored in the storage area so that the free space will be the calculated performance data capacity or more and then stores the acquired performance data in the storage area.

8. The data management method according to claim 7, wherein the controller makes a backup of all or part of the deleted performance data before the deletion of the existing performance data.

9. A controller for controlling a storage area storing performance data as data including performance information of a computer system and other data, wherein:
the controller assigns the storage area a preset storage capacity for storing the performance data,
acquires the performance data,
calculates a performance data capacity necessary for recording the acquired performance data in the storage area, and
stores the acquired performance data in the storage area if the calculated performance data capacity is smaller than free space in the assigned storage capacity, or else deletes existing performance data already stored in the storage area and then stores the acquired performance data in the storage area.

10. A program for a controller for controlling a storage area storing performance data as data including performance information of a computer system and other data, letting the controller conduct the steps of:
assigning the storage area a preset storage capacity for storing the performance data;
acquiring the performance data;
calculating a performance data capacity necessary for recording the acquired performance data in the storage area;
storing the acquired performance data in the storage area if the calculated performance data capacity is smaller than free space in the assigned storage capacity, or else deleting existing performance data already stored in the storage area and then storing the acquired performance data in the storage area.
